(19) United States
(12) Patent Application Publication
(10) Pub. No.: US 2011/0178240 A1
(43) Pub. Date: Jul. 21, 2011

(54) Process in Reactor to Prepare a Hybrid Polymeric Composition, Hybrid Polymeric Composition and Article

(75) Inventors: Edwin Moncada Acevedo, Medellin (CO); Fernando Silveira, Triunfo (BR)

(73) Assignee: Braskem S.A.

(21) Appl. No.: 12/970,334

(22) Filed: Dec. 16, 2010

(30) Foreign Application Priority Data
Dec. 16, 2009 (BR) PI0905174-0

(51) Int. Cl. C08K 3/34; C08K 3/10

(52) U.S. Cl. 524/731; 524/783

(57) ABSTRACT

The present invention refers to a polymeric composition with hybrid characteristics obtained in a polymerization reactor through the addition of an organometallic compound of Si, Ti, Al, Zr, Hf, Ge, V or Sn, to a growing polymer, during the step of propagation of the polymerization reaction.

Said hybrid polymeric composition has enhanced properties of sealing temperature, sealing initial temperature (SIT), barrier to gases and water vapor, printability, adhesion and scratch resistance, apart from retaining the superficial polarization of pieces and films for a longer time.

### FIELD OF THE INVENTION

The present invention refers to polymeric materials with hybrid characteristics obtained in a polymerization reactor through the addition of an organometallic compound of Si, Ti, Al, Zr, Hf, Ge, V or Sn, to a growing polymer, during the step of propagation of the polymerization reaction. The organometallic compound is added to the polymerization reaction so as to not chemically interact with the catalyst, co-catalyst, donor, monomer, comonomer, chain transfer agent or any other input or additive used in polymerization.

Said hybrid polymeric composition has enhanced properties of sealing temperature, sealing initial temperature (SIT), barrier to gases and water vapor, printability, adhesion and scratch resistance, apart from retaining the superficial polarization of pieces and films for a longer time. These properties are obtained without modifications of the mechanical properties.

### BACKGROUND

Polymeric materials, such as films and pieces, with improved surface and sealing properties, have been studied and obtained by different techniques described in the state of the art.

International application WO2007/040595 A2 reports the use of an organosilane which is added to the reaction of polyethylene copolymerization to expand the distribution of short chains in the obtained copolymer. Said patent application establishes that the addition of the organosilane occurs in the first or second reactor and may also lead to the modification of the flow rate of the resin which is being generated in the polymerization reaction. Although it is a modification of the polymer structure by the addition of organosilane compounds in reactor, the purpose of such application is different from the present invention. In the present invention, there is no change to the polymer structure and the modifying agent is dispersed among the polymer chains, being apt to migrate when the polymer is processed.

Patent application BR0516432-0 reports an enhanced process of the already known commercial process of chemical vapor deposition (CVD) also referred to as glow discharge in chemical vapor. The patent application reports the deposition of a layer of silicon oxide, siloxane or organosilane-silane polymerized by plasma over the surface of an organic polymeric substratum upon deposition with glow discharge of a gaseous mixture comprising a compound containing silicon and an oxidant. The process for the deposition of the layer of silane is performed upon mixing the silane with the oxidizing gas (N₂O) at the process of chemical vapor deposition. Such application uses the gases of generation of the chemical vapor deposition, such as carrier gas for silane, differing from the present invention where the compound silane is added by additivation to the polymeric mass and whose subsequent migration occurs due to a difference in polarity of the additive silane and resin, which consists of a simplified process, with less steps.

U.S. Pat. No. 4,988,657 reports a polymerization process for obtaining low-density polyethylenes, in which a catalyst containing chromium oxide supported over silica is chemically treated with a silane. The catalytic system chemically treated with silane produces comonomers which are inserted into the polymer, leading to density reduction and enlargement in the distribution of molecular weight. The main role of silane is to act over the reaction of termination of the growing polymeric chain by reducing the length of the chain.

U.S. Pat. No. 4,829,038 reports the use of modifiers based in alkoxy-silanes used as electron-donors in catalysts containing titanium and used in the synthesis of catalysts for polymerization of alpha-olefins leading to the formation of a complex with titanium. Therefore, it deals with the use of alkoxy-silanes for the synthesis of catalytic systems for propene polymerization. In this patent, alkoxy-silanes are added to the catalytic system in its synthesis, therefore becoming part of the chemical nature of the catalyst and not an additive, as in the present invention.

U.S. Pat. No. 6,559,221 B2 refers to the use of silanes or alkoxy-silanes in a polymerization reaction by emulsion by using a radical mechanism to perform polymerization and where group silane or alkoxy-silane is added to the polymeric chain at the end of it. The alkoxy-silane is chemically bound to the polymeric chain.

U.S. Pat. No. 4,297,310 claims a copolymerization process of ethylene with an unsaturated silane, enabled by insertion of silane in the polymer chains through a radical initiator in a high-pressure process using pressures between 2000 and 4000 kg/cm², with the purpose of enabling the insertion of silane in the polymer chains and the subsequent cross-link of silane through the condensation of groups silanol, seeking to obtain a polymer with good characteristics of electrical conductivity.

Therefore, the state of the art does not describe or suggests the achievement of a hybrid polymeric composition in a polymerization reactor through the addition of an organometallic compound of Si, Ti, Al, Zr, Hf, Ge, V or Sn, to a growing polymer, especially a polyolefin; said polymer presenting changes in the sealing characteristics and modification of the sealing window, as well as surface properties.

### SUMMARY OF THE INVENTION

The present invention is based on the homogenous dispersion of organometallic compounds of Si, Ti, Al, Zr, Hf, Ge, V or Sn during the obtainment of the polymer in the polymerization reaction of olefins; such dispersion does not present a chemical bond of these organometallic compounds with the growing polymer, stimulating the migration of these organometallic compounds up to the polymer surface when films or pieces are obtained and causing modification in the physical and chemical surface properties of these articles. In some steps of the present invention, it is possible to optionally treat said organometallic compound with a compound of alkyl-aluminum. Such treatment aims at ensuring that no interactions of the organometallic compound occur with the catalyst system.

In the present invention, it was obtained a hybrid polyolefin whose characteristic is the lack of chemical bond among the chains of polyolefins and the organometallic compounds during the process of polymerization and production of polyolefin.

It is possible to attest, through the present invention, that the interactions occurred between the organometallic compound (modifying agent) and the polyolefin cause the obtained hybrid material to present differentiated properties of reduction in the sealing initial temperature, sealing window, adhesion power, scratch resistance on the surface of pieces and films, printability and barrier characteristic, apart from retaining the superficial polarization of pieces and films for a longer time.

The hybrid polyolefin described herein is obtained by the addition of monomeric, oligomeric or organometallic polymeric compounds, such as organosilanes, organotitanates or organozirconates.

The way the organometallic compound interacts with polyolefin to modify the surface properties has not been described so far, and one did not expect an organometallic compound, when migrating to the film surface, to modify the sealing properties thereof, among other properties. Said migration of the organometallic compound to the surface occurs due to the polarity difference among the organometallic compounds and the polymeric matrix.

The literature contained in the state of the art does not describe or suggests the matter described and claimed in the present invention, once it does not present a hybrid polyolefin additivated with monomeric, oligomeric or polymeric compounds of organometallic compounds which does not present a chemical bond between the organometallic compound and the polymer and has, as foundation, the migration to the surface by the article generated so as to modify the properties previously mentioned and, besides, which is directly added to the polymerization system.

### BRIEF DESCRIPTION OF THE DRAWINGS

The present invention is illustrated based on the following figures:

FIG. 1: chart for comparison of the sealing windows of the films obtained with polyolefins and with hybrid polyolefins (an organosilane), in which:

PP-os-T=Film obtained with hybrid polyolefin and superficial modification;

PP-T=Film obtained with polyolefin and superficial modification;

PP-os=Film obtained with hybrid polyolefin;

PP=Film obtained from polyolefin.

FIG. 2: Chart for comparison of the sealing windows of films made with polyolefins with polyolefins and with hybrid polyolefins (different organosilanes), in which:

PP-os-T=Film obtained with hybrid polyolefin (using methyl trimethoxysilane) and superficial modification;

PP-os=Film obtained with hybrid polyolefin (using methyl trimethoxysilane);

PP-os.3-T=Film obtained with hybrid polyolefin (using phenyl trimethoxysilane) and superficial modification;

PP-os.3=Film obtained with hybrid polyolefin (using phenyl trimethoxysilane);

PP-T=Film obtained with polyolefin and superficial modification;

PP=Film obtained from polyolefin.

FIG. 3: Chart for comparison of the sealing windows of films made with polyolefins and with hybrid polyolefins (different organometallic compounds), in which:

PP-os-T=Film obtained with hybrid polyolefin (using organosilane methyl trimethoxysilane) and superficial modification;

PP-os=Film obtained with hybrid polyolefin using organosilane methyl trimethoxysilane);

PP-oz-T=Film obtained with hybrid polyolefin (using organozirconate-n butyl zirconate) and superficial modification;

PP-oz=Film obtained with hybrid polyolefin (using organozirconate-n butyl zirconate);

PP-T=Film obtained with polyolefin and superficial modification;

PP=Film obtained from polyolefin.

### DETAILED DESCRIPTION

The present invention refers to organic-inorganic hybrid polyolefins with properties differentiated from traditional polyolefins, properties such as: sealing initial temperature, sealing window, sealing temperature, welding adhesion force, and surface properties such as scratch resistance on the surface of pieces and films, printability and barrier characteristics, apart from retaining the superficial polarization of pieces and films for a longer period of time.

Hybrid polyolefin, according to the present invention, comprises monomeric, oligomeric or polymerized compounds of organometallic compounds such as: organosilanes, organotitanates or organozirconates dispersed in a polyolefinic polymeric matrix.

More particularly, the invention refers to a process in reactor to prepare a hybrid polymeric composition which comprises the steps:

a. Loading of the polymerization reactors with liquid propene between 2 and 4 mPa (20 and 40 bar) of pressure;

b. Addition of the catalyst-donor system to the reactor, and this catalyst may be such as Ziegler-Natta or metallocene or also a mixture of these two types of catalysts;

c. Heating until the reaction temperature;

d. Addition of the organometallic modifying agent after pre-contact, according to step (a) above, to the polymerization reactor and in the end of the step of propagation of the polymerization reaction, in which the modifying agent is freely dispersed in the polymeric matrix.

The invention also refers to a hybrid polymeric composition obtained by the process above, as well as to an article comprising said polymeric composition, which may be used in the packaging, petrochemical, food, pharmaceutical, automotive industries.

The present invention refers to a process for preparing a hybrid polyolefin comprising the following steps:

1. Pre-contact of the organometallic modifying agent with an alkyl-aluminum so as to protect the catalytic system of the polar groups of the organometallic compound. The amount of alkyl-aluminum employed ranges between 1 and 5% in mass in relation to the organometallic modifying agent employed; (this stage is optional and made to neutralize the possible contaminants comprising the modifying agent).

The modifying agent is an organometallic compound such as organosilane, organotitanate or organozirconate, which follows the formula below:

R′O-M-(OR″)₃

where R′ presents the structure CₙH₂ₙ₊₁, wherein index n may range from 1 and 22 carbon atoms and M may be an atom of titanium (Ti), zirconium (Zr), silicon (Si) and R″ presents the structure CₙH₂ₙ₊₁, wherein index n may range from 1 and 22 carbon atoms.

2. Loading of the polymerization reactors with liquid propene between 2 and 4 mPa (20 and 40 bar) of pressure. The loading of liquid propene is made through a differential of pressure between the reactor and the propene ball. The mass of propene used may range from 1.5 and 3 kg.

3. Addition of the catalyst-donor system to the reactor, and this catalyst may be such as Ziegler-Natta or metallocene or also a mixture of these two types of catalysts. The catalyst-donor system is previously mixed to a molar reaction ([metal/donor]) between 10 and 300;

4. Heating until the reaction temperature. After the loading with liquid propene and the catalyst-donor system, the system is closed and heated up to the temperature of 30° C. for a period of time from 5 to 60 minutes. After this heating time, the temperature is raised up to the range between 50 and 90° C.

5. Addition of the organometallic modifying agent after pre-contact, as written in item 1, to the polymerization reactor and in the end of the step of propagation of the polymerization reaction.

As previously described, it is important to highlight that the organometallic compounds used in the previous descriptions may or may not be replaced with alkyl groupings. The alkyl groupings are responsible for the hybrid characteristics of the obtained material.

The silicon alkoxides used are preferably ethyl triethoxysilane, methyl triethoxysilane, phenyl triethoxysilane, methyl trimethoxysilane, n-octyl ethoxysilane and n-butyl ethoxysilane. The titanium alkoxides used are preferably tetraethoxytitanium, ethyltriethoxy titanium, methyl triethoxytitanium, phenyl triethoxytitanium, n-octyl ethoxytitanium, n-butyl ethoxytitanium. The zirconium alkoxides used are preferably n-propylzirconate, n-butylzirconate and tetrapropylzirconate.

It is not contained in the state of the art that the addition of organometallic compounds to polyolefins presents changes to the sealing characteristics and modification of the sealing window, as well as it does not contain the addition of organometallic compounds to the reaction of polyolefin polymerization to be used as agents that modify the surface properties, among others, of the polymer.

Along this specification, the terms below have the following connotation:

Modifying agent—organosilanes, organotitanates, organozirconates;

Hybrid—compound with inorganic-organic characteristics;

Polyolefin—polymer obtained through the polymerization of nonomers and/or comonomers; it may be also merely treated as resin.

It is possible to better understand the invention by analyzing the examples below, which are described herein with merely illustrative and not limitative purposes, being possible to implement the invention by other means.

### Examples

The following examples are related to the obtainment of hybrid polymers, and their effect on the sealing and surface properties in polyolefins.

### 1. Obtainment of Hybrid Polyolefins and Determination of the Sealing Properties of the Films.

### 1.1. Obtainment of Hybrid Polyolefin.

Initially the polymerization reactor was loaded with liquid propene at a pressure of 2 mPa (20 bar), and the reactor was stored at a reaction temperature of 85° C. Afterwards, the catalyst-donor system was added to the reactor, the catalyst used was such as Ziegler-Natta, and the polymerization reaction started. In parallel, there was the pre-contact of methyl trimethoxysilane (modifying agent) with triethyl-aluminum (alkyl-aluminum) for a period of 15 minutes, and after an hour of reaction, the pre-contact mixture (methyl trimethoxysilane-triethyl-aluminum) was added to the polymerization reaction. The reaction is kept in a stationary state for a period of time and afterwards it remains still, thus obtaining the Hybrid Polyolefin.

In order to quantify the contents of silane dispersed in the polymer, XRF analyses (X-ray fluorescence spectroscopy) were performed, and the results of the incorporated content of organosilane are found in Table 1. It is possible to observe that, for the different concentrations of organosilanes added to the reactor, a high incorporation to the polymer was obtained, that is, there is little loss of silane in the polymerization system. Another important parameter is the catalytic activity which, compared to the polymer without the addition of silane (pure PP), did not present significant changes for low content of incorporated organosilane. However, when the contents of organosilane raised (1.4%), the catalytic activity reduced at approximately 30%. This decrease of the catalytic activity is within the range of oscillation of process generally observed in this type of reactor and may not be attributed to the organosilane.

TABLE 1
Results from the tests of propene polymerization with the addition
of an organosilane in contents between 0.7 and 1.4%.

| | Catalytic | Contents of | Contents of |
|---|---|---|---|
| | Activity | organosilane added | organosilane actually |
| | (kgPP/gram | to the reactor | incorporated into |
| Sample | of catalyst) | (% - m/m) | the polymer (% - m/m)* |
| Pure PP | 36 | 0 | 0 |
| PP-os-1 | 37 | 0.7 | 0.7 |
| PP-os-2 | 30 | 1.0 | 0.8 |
| PP-os-3 | 24 | 1.8 | 1.4 |

PP = polypropylene
PP-os = polypropylene with organosilane
*determined by XRF

### 1.2 Formation of the Film Using Hybrid Polyolefin.

Films with the hybrid polymers obtained in step 1.1 were generated. The films prepared with the hybrid polyolefin were compared regarding their sealing properties for films which suffered corona treatment of 40 dynes/cm and films without corona Treatment. The surfaces generated and studied regarding the sealing interactions were:

NT=Film surface Not modified with corona treatment for samples of polyolefin and hybrid polyolefin.

N=Film surface modified with corona treatment for samples of pure polyolefin and hybrid polyolefin.

### 1.3 Sealing Analyses.

To determine the modification in the sealing properties of the films produced with hybrid polyolefins the results obtained from the Hot-tack Tests (standard ASTM F-1921) and from the Ultimate test (standard ASTM F-2029) were analyzed.

Some common codifications in the Hot-tack and Ultimate analyses and which are part of the present description are:

NT-NT: Sealing analysis using a non-modified film surface (NT) in contact with another non-modified film surface (NT).

T-T: Sealing analysis using a film surface modified with corona treatment (T) in contact with another film surface modified with corona treatment (T).

### Hot-Tack

The Hot-tack test consists of determining the heat sealing force of the film surfaces at a specific temperature. With the data obtained in this test, the hot sealing window graph is built.

a. Sealing of Films Made with Hybrid Polyolefins by Using an Organosilane Compound

To determine the potential gained of the technology of hybrid polyolefins in the sealing properties, films of the hybrid polyolefins obtained with organosilane methyl trimethoxysilane were produced. The generated samples were:

PP-os-T=Film obtained with hybrid polyolefin and superficial modification;

PP-T=Film obtained with polyolefin and superficial modification;

PP-os=Film obtained with hybrid polyolefin;

PP=Film obtained from polyolefin

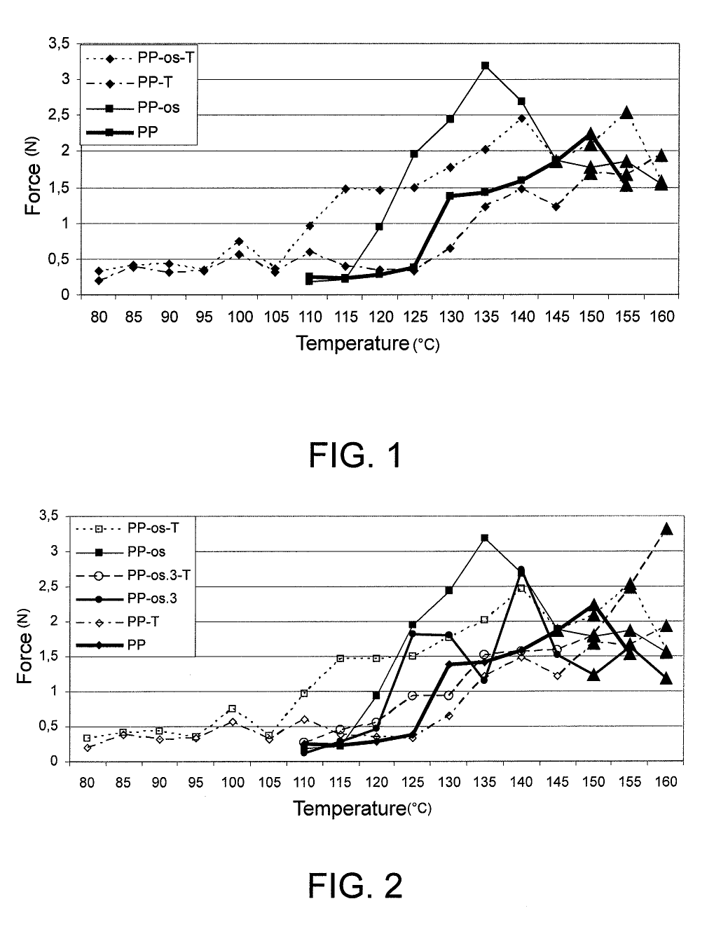

In FIG. 1, it is possible to observe the chart of the sealing windows which correspond to the films produced with and without an organosilane agent (PP, PP-T), films made with the addition of a modifying agent (PP-os) and films made with the addition of a modifying agent with superficial modification (PP-os-T).

In general, it is possible to observe a great modification of the sealing window in the samples made with the hybrid polyolefins (with addition of organosilane), both raising the force and reducing the temperature.

It is possible to observe that the greatest modification of the sealing window (in relation to the low temperatures of the chart) was obtained for film PP-os-T. For this sample, the main modification is observed in the sealing temperature when the force reaches 0.5 N, which compared to the film without addition of organosilane, presents a reduction of 20° C.

The sample of hybrid polyolefin without superficial modification ( [symbol] ) reaches a sealing force of 3.2 N at 135° C., even before sealing at 150° C.; that is, 77% above the force shown upon the sealing of the sample without organosilane.

It is clear that with and without the superficial modification of the film made with the hybrid polyolefin, a modification in the sealing window is obtained.

b. Sealing of Films Made with Hybrid Polyolefins by Using Different Organosilane Compounds

So as to compare the performance of the films obtained from polymers with different organosilanes, the organosilanes methyl-trimethoxysilane (alkyl-silane), phenyl-trimethoxysilane (aryl-silane) were tested. The generated samples were:

PP-os-T=Film obtained with hybrid polyolefin (using methyl trimethoxysilane) and superficial modification;

PP-os=Film obtained with hybrid polyolefin (using methyl trimethoxysilane);

PP-os.3-T=Film obtained with hybrid polyolefin (using phenyl trimethoxysilane) and superficial modification;

PP-os.3=Film obtained with hybrid polyolefin (using phenyl trimethoxysilane)

PP-T=Film obtained with polyolefin and superficial modification;

PP=Film obtained from polyolefin.

FIG. 2 shows the sealing window for the following samples: of a sample of polyolefin such as pure polypropylene (PP), of a sample of hybrid polyolefin such as the polypropylenes with methyl trimethoxysilane (PP-os) and polypropylene with phenyl trimethoxysilane (PP-os-3).

All the samples of hybrid polyolefins modified or not with Corona treatment presented modification in the sealing window at low temperatures (<125° C.). As previously shown, the samples with methyl trimethoxysilane present a greater reduction in the temperature when the achieved force was 0.5 N whereas the sample with phenyl trimethoxysilane (PP-os.3- [symbol] ) presents a reduction of the order of 5° C. in relation to pure polypropylene (PP- [symbol] ).

Sample PP-os-3 also reveals, in relation to the sealing force at the temperature of 135° C., a raise of the order of 200%.

The samples with organosilanes and modified with Corona treatment, PP-os.3-T ( [symbol] ) and PP-os-T ( [symbol] ), also demonstrated improvement in the reduction of the sealing initial temperature, confirming the tendency of better migration of the silane.

Once again it is possible to confirm the modification of the sealing window upon the use of hybrid polyolefins and not depending on the superficial modification of the film.

c. Sealing of Films Made with Hybrid Polyolefins by Using Different Organometallic Compounds

To demonstrate that different organometallic compounds may be used for the formation of hybrid polyolefins, organosilanes and organozirconates were used. The generated samples were:

PP-os-T=Film obtained with hybrid polyolefin (using organosilane methyl trimethoxysilane) and superficial modification;

PP-os=Film obtained with hybrid polyolefin (using organosilane-methyl trimethoxysilane);

PP-oz-T=Film obtained with hybrid polyolefin (using organozirconate-n butyl zirconate) and superficial modification;

PP-oz=Film obtained with hybrid polyolefin (using organozirconate-n butyl zirconate);

PP-T=Film obtained with polyolefin and superficial modification;

PP=Film obtained from polyolefin.

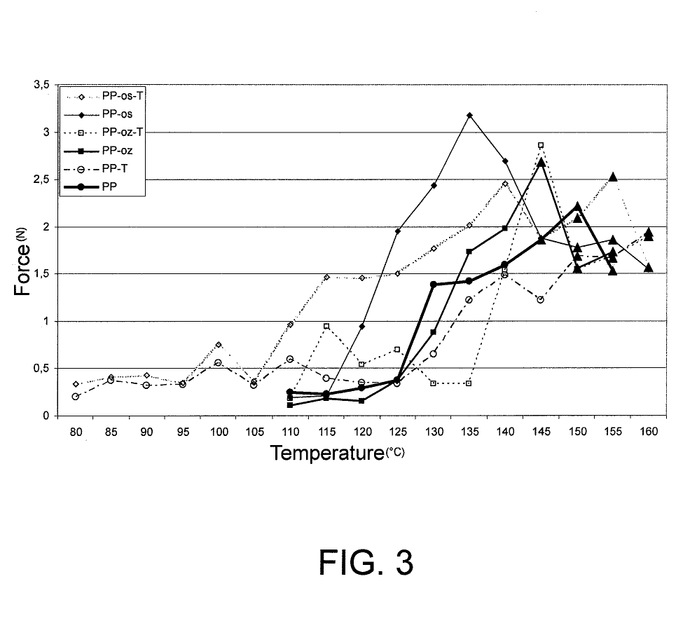

FIG. 3 shows the sealing window for the different hybrid polyolefins obtained with organometallic compounds. In general, it is possible to observe results which are similar to those observed for the studied compounds of organosilanes. These considerations mainly correspond to the raise of the sealing force and reduction of the sealing temperature when a force of 0.5N was achieved.

1. Process in reactor to prepare a hybrid polymeric composition, characterized in that it comprises the steps:
a. loading of polymerization reactor with liquid propene between 2 and 4 mPa (20 and 40 bar) of pressure;
b. introducing a catalyst-donor system to the reactor;
c. heating the reactor to a reaction temperature between 25° and 90° C.;
d. adding an organometallic modifying agent after pre-contact, according to step (a) above, to the polymerization reactor and, at an end of the polymerization reaction, in which the modifying agent is freely dispersed in a resulting polymeric matrix.

2. The process according to claim 1, characterized in that the modifying agent gets in touch with an alkyl-aluminum compound before step (a).

3. The process according to claim 1, characterized in that the modifying agent is an organometallic compound which follows the formula below:
R′O-M-(OR″)₃
where R′ presents the structure CₙH₂ₙ₊₁, wherein index n may range from 1 and 22 carbon atoms and M may be an atom of titanium (Ti), zirconium (Zr), silicon (Si) and R″ presents the structure CₙH₂ₙ₊₁, wherein index n may range from 1 and 22 carbon atoms.

4. The process according to claim 1, characterized in that the modifying agent is organosilane, organotitanate or organozirconate.

5. The process in reactor, according to claim 1, characterized in that a monomer in the reaction comprises propene, ethylene, or a mixture thereof.

6. The process according to claim 1, characterized in that the catalyst is a Ziegler-Natta or metallocene or a mixture thereof.

7. The process according to claim 1, characterized in that the modifying agent is added between the contents from 0.01 to 40% (w/w) in the polymer.

8. The process according to claim 1, characterized in that the modifying agent is capable of changing a sealing window of the polymer.

9. The process according to claim 1, characterized in that the polymer produced shows an increase of up to 200% in the sealing force.

10. The process according to claim 1, characterized in that the polymer produced shows a modification in the sealing window in up to 20° C. in relation to a polymer produced without the modifying agent.

11. A hybrid polymeric composition obtained the process described in claim 1.

12. An article, characterized in that it comprises the polymeric composition as defined in claims 11.
